(19) United States
(12) Patent Application Publication
(10) Pub. No.: US 2007/0180269 A1
(43) Pub. Date: Aug. 2, 2007

(54) I/O address translation blocking in a secure system during power-on-reset

(75) Inventors: John D. Irish, Rochester, MN (US); Charles R. Johns, Austin, TX (US); Chad B. McBride, Rochester, MN (US); Ibrahim A. Ouda, Rochester, MN (US); Andrew H. Wottreng, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/344,901

(22) Filed: Feb. 1, 2006

(51) Int. Cl. G06F 12/14

(52) U.S. Cl. 713/193

(57) ABSTRACT

A method and apparatus for the prevention of unwanted access to secure areas of memory during the POR or boot sequence of a CPU. Via control within the CPU, commands that are sent to and received by the CPU prior to the finish of the POR sequence can be denied I/O address translation, thus protecting memory during the POR sequence. Furthermore, an error response can be generated in the CPU and sent back to the I/O device which issued the command.

### BACKGROUND OF THE INVENTION

1. Field of the Invention

The present invention generally relates to preventing malicious accesses to memory during a reset sequence of a processor.

2. Description of the Related Art

Computing systems often include central processing units (CPUs). Often requests to execute I/O commands are made to the CPU from other devices within a system. Examples of devices which may make an I/O command request to a CPU include a video card, sound card, or other type of I/O device within a system. When a CPU is reset or powered on for the first time it executes a boot or power-on-reset (POR) sequence. During this sequence the CPU performs tasks related to readying the processor for use. Examples of tasks executed during a POR sequence are clearing registers, initializing the memory logic of the microprocessor, and performing test sequences to ensure proper operation.

The execution of the POR sequence tasks takes a significant amount of time. While the POR sequence is executing, the I/O interface of the processor may be active and able to accept I/O commands. This creates an opportunity for external devices, such as those connected to an I/O (Input/Output) interface, to issue read and write commands to memory. This time period may be large enough to allow a read or write operation to a secure area of memory that is not available to the external devices after the boot sequence and not intended to be available to I/O devices during the POR sequence. Examples of secure areas of memory are main memory, the local memory of an additional on-chip CPU, or registers included in a memory map. An individual may take advantage of this opportunity to take control of the CPU or its services in order to use the processor in an unintended, malicious, and/or illegal manner. Thus, the opportunity to access secure areas of memory during the boot sequence is a security hole for CPUs and their corresponding systems.

Therefore, there is a need for a method and apparatus for protecting secure areas of memory during the boot or POR sequence of a CPU.

### SUMMARY OF THE INVENTION

The present invention generally provides methods and apparatus for protecting secure areas of memory during the boot or POR sequence of a CPU.

One embodiment provides a method of protecting secure areas of memory during a processor reset sequence. The method generally includes (a) setting an initial state of the processor to prevent memory access from external devices upon a reset of the processor, and (b) changing the initial state of the processor to a new state after the processor reset sequence is complete to allow memory access from external devices.

Another embodiment provides another method of protecting secure areas of memory during a processor reset sequence. The method generally includes: (a) during the reset sequence, preventing I/O address translation for an I/O command received from an external I/O device; and (b) after the processor reset sequence is complete, allowing I/O address translation for an I/O command received from an external I/O device.

Another embodiment provides a processing device generally including I/O address translation logic and processor reset sequence logic. The I/0 address translation logic is generally configured to perform I/O address translation for an I/O command received by the processing device. The processor reset sequence logic is generally configured to control the I/O address translation logic to set an initial state of the processing device to prevent memory access from external devices during a reset sequence of the processing device, and to change the state of the processing device to a new state after the processor reset sequence is complete to allow memory access to non-secure areas of memory from external devices.

Another embodiment provides a system generally including one or more external I/O devices and a processing device. The processing device generally includes I/O address translation logic and processor reset logic. The I/O address translation logic is generally configured to perform I/O address translation for a command received by the processing device. The processor reset sequence logic is generally configured to control the I/O address translation logic to set an initial state of the processing device to prevent memory access from external devices during a reset sequence of the processing device, and to change the state of the processing device to a new state after the processor reset sequence is complete to allow memory access to non-secure areas of memory from external devices.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computing environment, according to one embodiment of the invention.

FIGS. 2A & 2B are flowcharts illustrating the prevention of I/O address translation of I/O commands received from I/O devices during a boot sequence, according to one embodiment of the invention.

FIG. 3 is a block diagram illustrating logic used to prevent I/O address translation during a power on reset sequence, according to one embodiment of the invention.

### DETAILED DESCRIPTION OF THE PREFERRED EMBODIMENTS

Embodiments of the present invention allow for the prevention of unwanted access to secure areas of memory during the POR or boot sequence of a CPU. Via control within the CPU, I/O commands that are sent to and received by the CPU prior to the finish of the POR sequence can be denied I/O address translation, thus protecting memory during the POR sequence. Furthermore, an error response can be generated in the CPU and sent back to the I/O device which issued the I/O command. Preventing I/O address translation in this manner improves the security of the CPU and consequently a computing system utilizing such a CPU.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

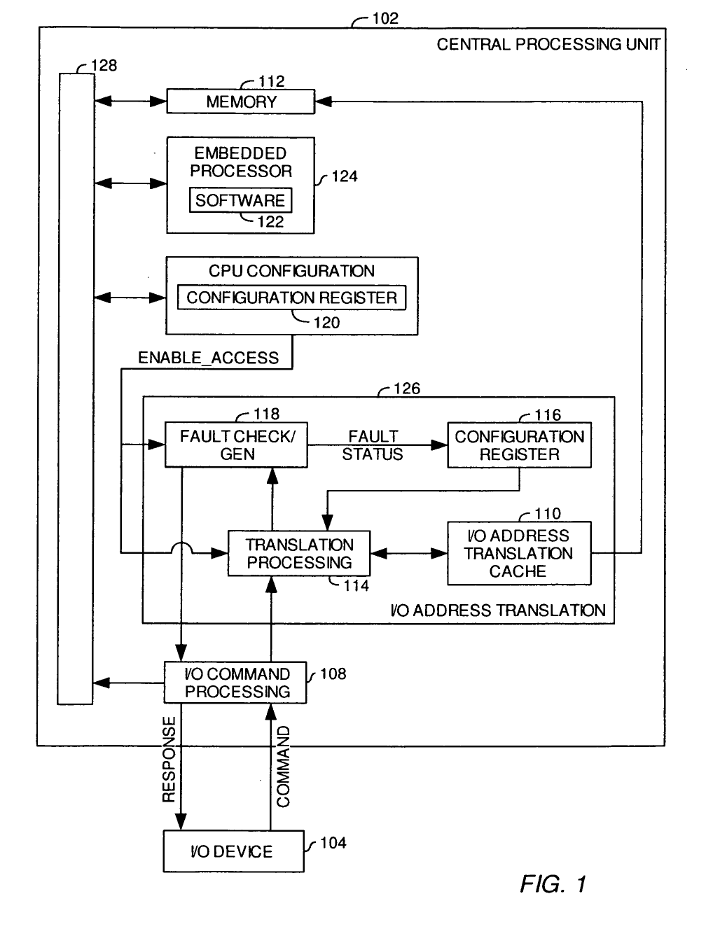

FIG. 1 is a block diagram illustrating a central processing unit (CPU) 102 coupled to an I/O device 104, according to one embodiment of the invention. In one embodiment, the CPU 102 may reside within a computer system such as a personal computer or gaming system. The I/O device 104 may also reside within the same system. In a modern computing system there may be a plurality of I/O devices 104 attached to the CPU 102, such as a video card, or a hard drive. The I/O device 104 may be physically attached to the CPU 102 inside of the computing system by means of a bus.

An I/O device 104 will send I/O commands to the CPU 102 for execution, and the CPU 102 may respond to the I/O device 104 with a result. In one embodiment, I/O command processing logic 108 may reside within the CPU 102. Within the I/O command processing logic 108, I/O commands sent from I/O devices 104 are stored and prepared for execution by the CPU 102.

Input/output commands sent by an I/O device 104 often target a memory address within the computing system. As I/O commands are sent to the processor from I/O devices, the I/O command refers to a virtual memory address rather than the physical memory address corresponding to the data location in physical memory. The CPU 102 may contain memory 112 and I/O address translation logic 126 to aid in the translation of virtual memory addresses to physical memory addresses and to reduce memory access latency. Within the I/O address translation logic 126 may be an I/O address translation cache 110 and translation processing logic 114. The I/O address translation logic 126 may also contain configuration registers 116 to control access to areas of memory or I/O devices. Furthermore, the CPU 102 may contain an embedded processor 124 for executing I/O commands sent for processing by the I/O command processing logic 108. Within the embedded processor may be software 122 running to control functionality of the embedded processor 124. Also within the CPU 102 may be a bus 128 for the exchange of information amongst different logic devices within the CPU 102.

In one embodiment, the I/O address translation logic 126 may contain a fault check and generation logic 118 to detect faults (e.g. page or segment table faults and the like) related to I/O commands received by the CPU 102. The fault check and generation logic 118 may also be used to alert the CPU 102 and other devices or systems of such faults. The fault check and generation logic 118 may alert the I/O command processing logic 108 when faults have occurred.

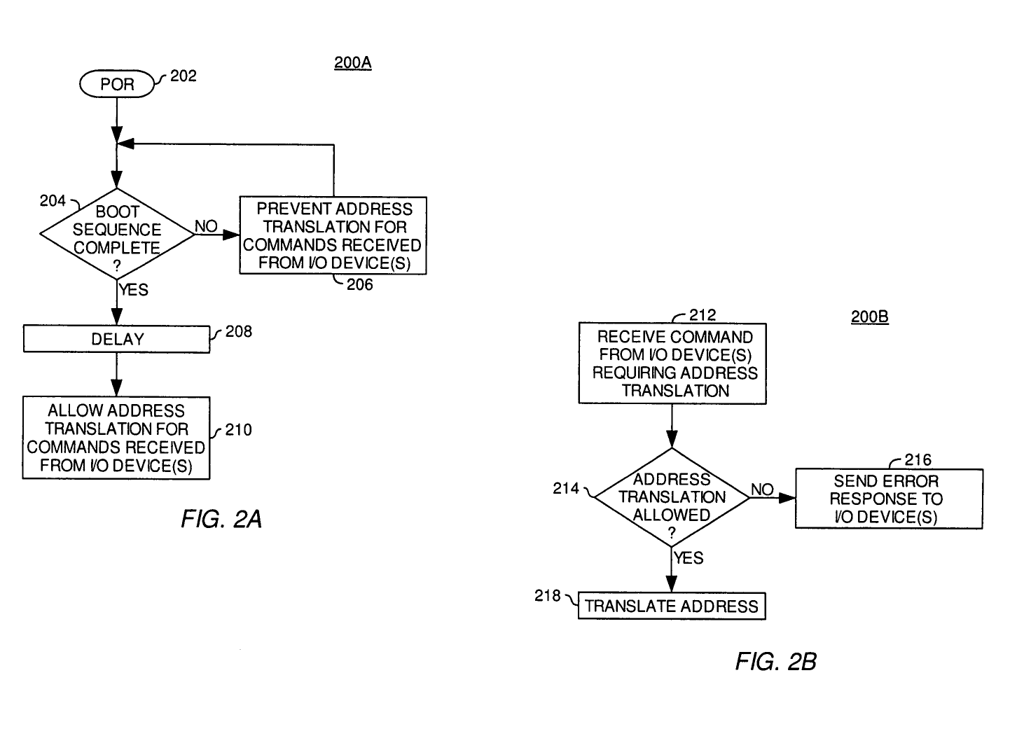

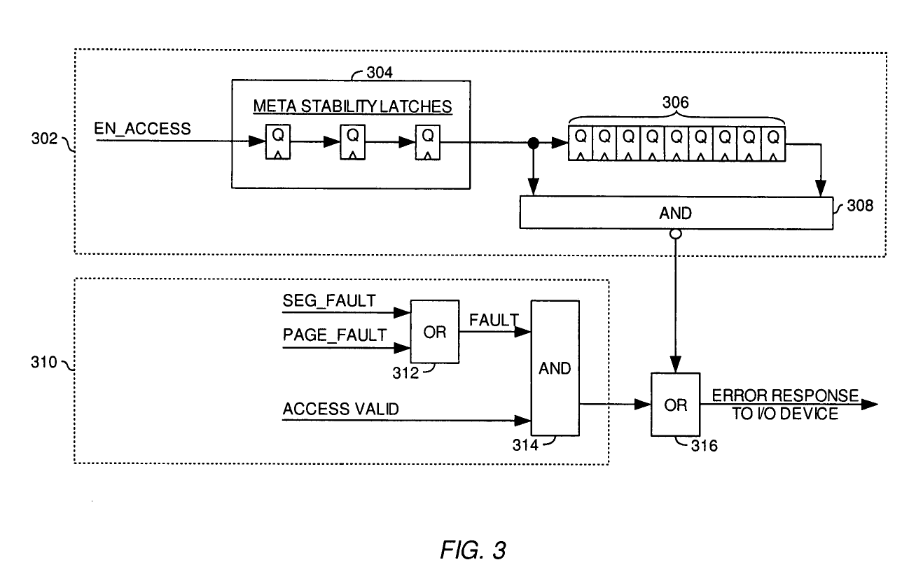

For some embodiments, the fault check and generation logic 118 may be used to prevent I/O address translation of I/O commands during the POR sequence. An I/O command sent to the CPU 102 by an I/O device 104 during the POR sequence may be a malicious I/O command sent by an intruder that is trying to gain access to secure areas of memory. In one embodiment, the CPU 102 can be protected by such a malicious I/O command by denying the I/O command access to memory. After the POR sequence is complete an I/O command may be allowed access to non-secure areas of memory, by loading an I/O translation device with entries corresponding to non-secure areas of memory. In another embodiment of the invention, the CPU 102 can be protected by such a malicious I/O command by denying the I/O command I/O address translation during the POR sequence. Exemplary operations performed by the fault check and generation logic 118 to detect I/O commands sent during the POR sequence, to deny I/O address translation to such I/O commands, and to alert other logic of such I/O commands are further described in FIGS. 2A-B. An exemplary embodiment of fault check and generation logic 118 is further described in FIG. 3.

Also within the CPU 102 may be a configuration register 120 used to set the initial state of the CPU 102 upon a POR. The configuration register 120 may set the state of the CPU to control access to I/O address translation, or to set the state of devices within the CPU which enable I/O address translation. Within the configuration register 120 may be a bit used to control the access to I/O address translation for I/O commands (e.g., via a bit/signal called “enable_access”). In one embodiment, enable_access, is provided to the fault check and generation logic 118. This signal may be used to establish the period of time after POR I/O address translation of I/O commands will be prevented. The bit in the configuration register 120, and consequently the enable_access signal, may initially be de-asserted (e.g. set to a ‘0’ or low), which may indicate that no I/O address translation of I/O commands received from an I/O device may take place immediately following a POR. I/O address translation may continue to be blocked until the bit in the configuration register 120 is asserted (e.g., set to a ‘1’ or high) by software 122 after completion of the POR sequence. Thus, the CPU 102 can protect itself during the POR sequence from unwanted access via malicious I/O commands by preventing I/O address translation of all I/O commands received during the POR sequence.

### Exemplary Operations

FIG. 2A is a flowchart illustrating operations 200 for preventing I/O address translation of an I/O command received from an I/O device 104 during the POR sequence of the CPU 102, according to one embodiment of the invention. The operations 200 illustrate operations performed by the fault check and generation logic 118 described in FIG. 1.

The operations 200 begin when a CPU 102 enters a POR state or sequence 202. As described above, the initial state of the CPU 102 may have enable_access initially de-asserted to indicate that no I/O command is allowed I/O address translation immediately following a power-on or reset of the CPU 102. As long as the POR sequence is still progressing, as determined at step 204, I/O address translation is prevented at step 206. The fault check and generation logic 118 may continue to block or prevent I/O address translation of I/O commands as illustrated in step 206 until the POR sequence is complete. In one embodiment of the invention, during the POR sequence the address translation cache 110 may be initialized to an invalid state and remain that way until a period of time after the POR sequence is complete. Once the POR sequence is complete, software 122 within the embedded processor 124 is able to adequately protect secure areas of memory via I/O address translation. In some embodiments, a delay may be initiated after the POR sequence is complete.

A delay may be implemented to ensure that I/O commands received in the I/O command processing logic 108 before POR the sequence was finished, are flushed from logic devices in the CPU, and are not provided I/O address translation. Thus, potentially malicious I/O commands are denied I/O address translation during the latency period caused by software 122 or the processing of the enable_access signal in the fault check and generation logic 118. After the delay 208, I/O address translation for I/O commands will be allowed.

FIG. 2B is a flowchart illustrating operations 200B of processing an I/O command sent by an I/O device 104 to a CPU 102, according to one embodiment of the invention. At step 212, I/O commands requiring I/O address translation are received. If the processor has finished the POR sequence and a delay period required to flush out any I/O commands received during the POR sequence has expired, I/O address translation may be performed at step 218. If the POR sequence has not expired, at step 216 the I/O command may be ignored or discarded and an error response is sent to the I/O device 104.

### Exemplary Fault Check and Generation Logic

FIG. 3 is a block diagram illustrating exemplary logic circuits which may be used to implement fault check and generation logic 118, according to one embodiment of the invention. The fault check and generation logic 118 may be used to generate an error response to send to other CPU 102 logic such as I/O command processing 108. Consequently, an error response may be sent to an I/O device 104 that has sent an I/O command to the CPU 102 during the POR sequence. Hereinafter such an error response or signal will be referred to as the “error response to I/O device” as shown in FIG. 3. As illustrated in FIG. 3, the fault check and generation logic 118 may be composed of two parts: a POR fault generation component 302 and an I/O address translation fault generation component 310.

The POR fault generation component 302 may contain a chain of meta-stability latches 304, used to capture the enable_access signal which is asynchronous to the processor clock. These latches may latch in the enable_access signal as previously described. A low or de-asserted enable_access signal present at the input of the meta-stability latches 304 will cause a low signal at the output of the meta-stability latches. Consequently, a low signal will be present at the input of the “and” gate 308 which is connected to the output of the meta-stability latches 304. The state of the signal output from the “and” gate is negated and then fed into an “or” gate 316. The presence of the low signal at the “and” gate 308, due to the initial low state of the enable_access signal, will cause the “error response to I/O device” signal to be asserted. Thus, following a power-on or reset of the CPU 102 the “error response to I/O device” is asserted. This signal may indicate to the other logic devices within the CPU 102, such as I/O command processing 108, and consequently to an I/O device 104, that any I/O command received during the POR sequence may not be allowed I/O address translation.

Software 122 executing within the embedded processor may determine when the POR sequence is finished and the software 122 can adequately protect secure memory areas. Therefore, it may be safe to allow I/O commands access to I/O address translation services. The “error response to I/O device” signal may be turned off to signal to other logic devices within the CPU 102 that I/O commands may be allowed access to I/O address translation services.

The “error response to I/O device” signal may be turned off by asserting a bit, setting to ‘1’ or high, within the configuration register 120 by software 122. Now enable_access is asserted and will be latched in by the chain of meta-stability latches 304. The output of the chain of meta-stability latches 304 is connected to both an “and” gate 308 and a chain of latches 306. The chain of latches 306 is synchronized to the processor clock. The chain of latches 306 is present to create a delay 208, as described above in FIG. 2. The number of latches within the chain of latches 306 may be increased or decreased to set the exact amount of delay desired. Every clock cycle the output of the meta-stability latches is latched into the next latch in the chain of latches 306. The final latch in the chain of latches 306 is also connected to the “and” gate 308. Thus, when the enable_access signal has been “latched in” by each of the latches in the chain of latches 306 (illustrated in FIG. 3 by nine latches which would correspond to nine clock cycles) a ‘1’ is present at the output of the chain of latches 306. If a ‘1’ is still present at the output of the meta-stability latches 304 and a ‘1’ is now present at the end of the chain of latches 306, the output of the “and” gate 308 will cause the “error response to I/O device” signal to be turned off, and thus no “error response to I/O device” signal sent out to other CPU 102 logic devices. Consequently, I/O address translation may now be performed by the other logic devices the CPU 102.

The purpose of “and”ing the output of the meta-stability latches 304 and the chain of latches 306 is to ensure that the signal generated from en_access is turned off more quickly than it is turned on. For example, if en_access is de-asserted the “error response to I/O device” signal is sent out to I/O devices rather quickly because the signal only has to latch into the three asynchronous meta-stability latches 304. However, if en_access is asserted the “error response to I/O device” signal isn't stopped until the three asynchronous meta-stability latches have latched in en_access and all of the latches within the chain of latches 306 have latched in en_access (i.e. a longer period of time). Thus, I/O address translation is disabled, i.e. security enabled, more quickly than I/O address translation is enabled.

For some embodiments the POR fault generation component 302 may be combined with conventional I/O address translation fault generation logic. For example, by sending the output of the POR fault generation component 302 to the “or” gate 316 which also receives the output of the I/O address translation fault generation logic 310. Thus, both portions of the fault check and generation logic 118 may independently assert the “error response to I/O device” signal.

The I/O address translation fault generation component 310 makes up a separate portion of the fault check and generation logic 118. The I/O address translation fault generation component 310 may be present in the fault check and generation logic 118 regardless of whether or not the POR fault generation component 302 is present. The I/O address translation fault generation component 310 of the fault check and generation logic 118 receives several signals from the translation processing logic 114. Two of the signals, seg_fault and page_fault, indicate faults related to the memory cache 110.

These two signals may be fed into an “or” gate 312 to generate the fault signal. The fault signal indicates whenever there has been either a segment fault or a page fault. The I/O address translation fault generation component 310 also receives an access valid signal from the translation processing logic 114. The access valid signal may indicate when the translation processing logic 114 has received a valid I/O command from an I/O device 104. The access valid signal and the fault signal are fed into an “and” gate. The results of the “and” of the fault signal and the access valid” signal indicate when a valid I/O command has been received and either a segment fault has occurred or a page fault has occurred due to the valid I/O command. If a segment fault or a page fault has occurred and a valid I/O command has been received the “error response to I/O device” signal will be asserted.

Thus, by sending both the output of the I/O address translation fault generation component 310 and the output of the POR fault generation component 302 to an “or” gate, both components can independently generate the “error response to I/O device” signal. Furthermore, by combining the POR fault generation component with conventional fault generation logic, such as the I/O address translation fault component, existing logic devices are leveraged to prevent malicious access attempts to secure areas of memory during POR. For some embodiments, a device which receives such an error response may determine the cause of the error response, for example, by checking a status register.

### Conclusion

Through the use of an internal control, a CPU may restrict access to I/O address translation services during, and for a period of time following, a POR. The control may also be used to indicate to external I/O devices that I/O commands received during the POR sequence may not be processed. As a result of restricting access to I/O address translation services within the CPU during a POR sequence, the CPU can adequately protect secure areas of memory from malicious attacks during a POR sequence.

While the foregoing is directed to embodiments of the present invention, other and further embodiments of the invention may be devised without departing from the basic scope thereof, and the scope thereof is determined by the claims that follow.

What is claimed is:

1. A method of protecting secure areas of memory during a processor reset sequence, comprising:
(a) setting an initial state of the processor to prevent memory access from external devices upon a reset of the processor;
(b) changing the initial state of the processor to a new state after the processor reset sequence is complete to allow memory access from external devices.

2. The method of claim 1, wherein the initial state of the processor is determined by a bit in a configuration register.

3. The method of claim 1, wherein changing the initial state of the processor to a new state comprises loading an I/O address translation device with entries that correspond only to non-secure areas of memory.

4. The method of claim 1, further comprising, based on the initial state of the processor, sending an error response to an external I/O device that sent a command during the reset sequence.

5. The method of claim 1, further comprising, waiting a predefined period of time after completion of the processor reset sequence before allowing I/O address translation for a command received from an external I/O device.

6. A method of protecting secure areas of memory during a processor reset sequence, comprising:
(a) during the reset sequence, preventing I/O address translation for a command received from an external I/O device; and
(b) after the processor reset sequence is complete, allowing I/O address translation for a command received from an external I/O device.

7. The method of claim 6, further comprising, after the processor reset sequence is complete, loading an I/O address translation device with entries that correspond only to non-secure areas of memory.

8. The method of claim 6, further comprising, sending an error response to the external I/O device which sent the command during the processor reset sequence.

9. A processing device, comprising:
I/O address translation logic configured to perform I/O address translation for a command received; and
processor reset sequence logic configured to control the I/O address translation logic to set an initial state of the processor to prevent memory access from external devices during a reset sequence of the processing device, and to change the state of the processing device to a new state after the reset sequence of the processing device is complete to allow memory access to non-secure areas of memory from external devices.

10. The processing device of claim 9, wherein the processor reset sequence logic is further configured to send an error response to the external I/O device which sent the command during the reset sequence of the processing device.

11. The processing device of claim 9, wherein the processor reset sequence logic is further configured to wait a predefined period of time after completion of the reset sequence of the processing device before allowing I/O address translation for a command received from an external I/O device.

12. The processing device of claim 9, further comprising:
a configuration register storing at least a bit; and
wherein the processor reset sequence logic is configured control I/O address translation logic to prevent I/O address translation for a command received from an external I/O device during the reset sequence of the processing device based on the initial state of the bit after a reset of the processing device.

13. The processing device of claim 12, wherein the state of the bit stored in the configuration register is changed to a new value after the reset sequence of the processing device is complete.

14. A system comprising:
one or more external I/O devices;
a processing device, comprising I/O address translation logic configured to perform I/O address translation for a command received, and comprising processor reset sequence logic configured to control the I/O address translation logic to set an initial state of the processing device to prevent memory access from external devices during a reset sequence of the processing device, and to change the state of the processing device to a new state after the processor reset sequence is complete to allow memory access to non-secure areas of memory from external devices.

15. The system of claim 14, wherein the processor reset sequence logic of the processing device is further configured to send an error response to the external I/O device which sent the command during the reset sequence of the processing device.

16. The system of claim 14, wherein the processor reset sequence logic of the processing device is further configured to wait a predefined period of time after completion of the reset sequence of the processing device before allowing I/O address translation for a command received from an external I/O device.

17. The system of claim 14, wherein the processing device further comprises:
a configuration register storing at least a bit; and
wherein the processor reset sequence logic is configured to prevent I/O address translation for a command received from an external I/O device during a reset sequence of the processing device based on the initial state of the bit after a reset of the processor.

18. The system device of claim 17, wherein the state of the bit stored in the configuration register is changed to a new value after the processor reset sequence is complete.
